(19) United States
(12) Patent Application Publication
(10) Pub. No.: US 2003/0046392 A1
(43) Pub. Date: Mar. 6, 2003

(54) Automatic network connecting system and method

(76) Inventors: Sayling Wen, Taipei (TW); Kuang Shin Lin, Taipei (TW); Xing-Jia Wang, Tianjin (CN)

Correspondence Address: BIRCH STEWART KOLASCH & BIRCH, PO BOX 747, FALLS CHURCH, VA, 22040-0747, US

(21) Appl. No.: 09/940,534

(22) Filed: Aug. 29, 2001

(51) Int. Cl. G06F 15/173

(52) U.S. Cl. 709/225; 709/227

(57) ABSTRACT

An automatic network connecting system includes a database, a data managing module, a user interface module and a responding module. The database stores user private data and network connection public data. The data managing module accesses the user private data and the network connection public data stored in the database. The user interface module provides at least one prompt to a user, so that the user can input a network service request according to the prompt in one touch. The responding module receives the network service request and accessing the user private data and the network connection public data stored in the database through the data managing module according to the network service request to complete the network service requested by the user automatically.

### BACKGROUND OF THE INVENTION

1. Field of the Invention

The invention relates to a network connecting system and method and, more particularly, to an automatic network connecting system and method that connects to a network automatically according to the service request input by a user by one touch.

2. Related Art

Existing PC (Personal Computer) operating systems, such as Microsoft Windows OS, and freeware Linux have great designs and are equipped with various functions. However, they sometimes still are not sufficiently intuitive and simple to operate.

Feature-rich and sophisticated they may be, however, those very features and sophistication themselves also constitute, on many occasions, serious psychological barriers for computer-novices. These barriers automatically arise for many novice users as they attempt to use the computer not only because the typical PC OS is complex and feature-laden, but also because there are at least several procedural steps to take before any of the more simple and intuitive computer applications can be launched and used.

To power up a computer and bring up an application, a user has to boot up the system, access the physical interface of the system via devices such as a keyboard and/or mouse, locate the whereabouts of the particular application software from the desktop icon array, and then actually launch the application.

Even after the user has successfully brought the desired software application up and running, the process of using the application will most likely involve interacting with the application via one or more of several forms of user interfaces. Sometimes, a combination of these interfaces will have to be used. Typical of these user interfaces are graphical (GUIs) and multimedia types initiated through the use of a mouse, keyboard, microphone, and the like. However, since almost all of the most popular software application programs are marketed in English versions, and even the non-English version software programs inevitably contain English messages in the interfaces they provide, for non English-speaking or barely literate users, even these popular GUIs and other multimedia interfaces constitute obstacles to computer access and productive use.

Thus, an easy-to-use computer application software system should look, feel friendly and be encouraging rather than frightening. A friendly and encouraging application system should be fool-proof in that the user knows he or she will never physically damage the computer, crash the OS, or lose data simply by attempting different commands on the computer. A simple computer application system is therefore desirable for those intending to learn and use computers for the first time and then for simple daily activities such as keeping phone numbers and addresses, web browsing, and many other intuitive applications.

For example, when a user wants to browse Internet web pages of an HTTP server using the Windows or Linux OS, he/she must complete the network connection procedures manually. In the network connection procedures, the user has to input the domain name or IP address of the ISP server. The user also has to input his/her account ID and password. After finishing the above-mentioned procedure, the user must input the domain name of the HTTP server into a web browser to browse the web pages.

To the users who are not familiar with computer or network technology, to finish the above-mentioned procedures is very difficult. Thus, the intentions of those users to use computers to connect to the Internet are lowered. Even for experienced users, the procedures are very inconvenient for them.

Therefore, it is an important issue to provide a network connecting system and method that has an intuitive correspondence with the experience in real life to facilitate the network-connecting operation.

### SUMMARY OF THE INVENTION

In view of the above, an objective of the invention is to provide an automatic network connecting system and method that has an intuitive correspondence with the experience in real life to facilitate the network-connecting operation.

To achieve the above objective, the automatic network connecting system according to the invention includes a database, a data managing module, a user interface module and a responding module. The database stores user private data and network connection public data. The data managing module accesses the user private data and the network connection public data stored in the database. The user interface module provides at least one prompt to a user, so that the user can input a network service request according to the prompt in one touch. The responding module receives the network service request and accessing the user private data and the network connection public data stored in the database through the data managing module according to the network service request to complete the network service requested by the user automatically.

In an aspect of the invention, the database includes a private sub-database for storing the user private data, and a public sub-database for storing the network connection public data. The data managing module includes a private data managing sub-module for accessing the user private data stored in the private sub-database, and a public data managing sub-module for accessing the network connection public data stored in the public sub-database.

In an aspect of the invention, the responding module includes a network-connecting sub-module for establishing network connection and a network-disconnecting sub-module for disconnecting the established network connection.

The so-called “one touch” refers to the single action for inputting a request by hitting a key on the keyboard. In an aspect of the invention, the one touch is a hitting of a key. However, the one touch can also be a clicking of a mouse or a sound of a voice.

According to the invention, a user can send a web page browsing request as a network service request by hitting a key on the keyboard of a computer. The automatic network connecting system firstly establishes a connection with the ISP server to connect the computer with the Internet, then it connects the computer to a web server so that the user can browse the web page requested. Thus, the network connecting procedure is simplified, and the operation efficiency of the user is improved.

### BRIEF DESCRIPTION OF THE DRAWINGS

The invention will become more fully understood from the detailed description given hereinbelow illustration only, and thus are not limitative of the invention, and wherein:

FIG. 1 is a schematic view showing the configuration of the automatic network connecting system according to the preferred embodiment of the invention;

FIG. 2 is a flow chart showing the procedures of the automatic network connecting method according to the preferred embodiment of the invention;

FIG. 3(A) is a schematic view showing one screen of a user using the automatic network connecting system according to the preferred embodiment of the invention; and

FIG. 3(B) is a schematic view showing another screen of a user using the automatic network connecting system according to the preferred embodiment of the invention.

### DETAILED DESCRIPTION OF THE PREFERRED EMBODIMENT

The invention will be apparent from the following detailed description, which proceeds with reference to the accompanying drawings, wherein the same references relate to the same elements.

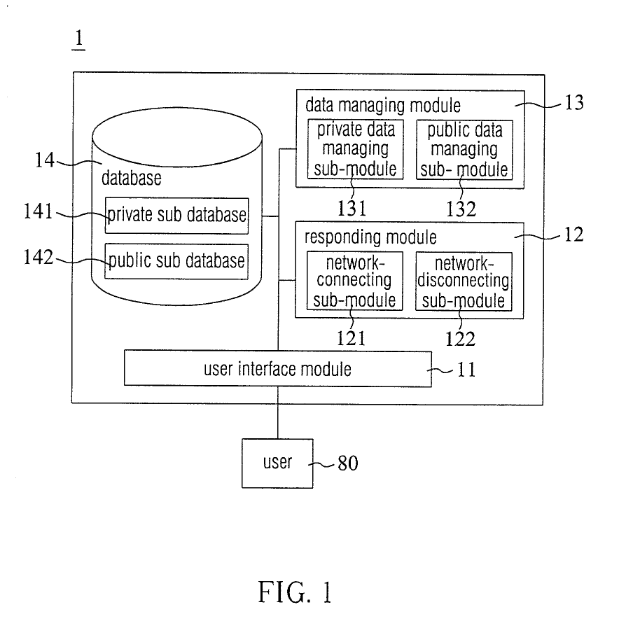

Referring to FIG. 1, the automatic network connecting system 1 according to the preferred embodiment of the invention includes a user interface module 11, a responding module 12, a data managing module 13 and a database 14. The user interface module 11 provides a user with at least one prompt, so that the user can input a network service request according to the prompt in one touch. After receiving the network service request, the responding module 12 retrieves the necessary data from the database 14 via the data managing module 13, and completes the network service the user requested.

In the preferred embodiment, the automatic network connecting system 1 is implemented in a computer. The computer includes a CPU (Central Processing Unit), a storage device and other peripheral devices for accomplishing the desired functions (input device such as a keyboard or a mouse and output device such as a monitor or a printer). Electrical signals with concrete physical quantities are used to record or transmit information among the above-mentioned devices. However, it should be noted that the automatic network connecting system 1 could be implemented in any kind of electronic device, such as a PDA, a notebook computer or a mobile communication device.

In the preferred embodiment, the user interface module 11, the responding module 12 and the data managing module 13 can be program modules stored in the computer-readable storage device. The storage device can be any computer readable data storage device, such as a HDD (Hard Disk Drive), a CD-ROM, a DRAM module, an EEPROM module or a floppy disk drive. The database 14 can be, for example, an ACCESS database, a SQL database or any customized database configured by a programmer according to the actual requirements.

The user interface module 11 provides at least one “prompt”, so that a user can input a network service request according to the prompt in one touch. In the preferred embodiment, the so-called “one touch” refers to the single action for inputting a request by hitting a key on the keyboard. The keys on the keyboard can be grouped into “basic keys” and “auxiliary keys”. The “basic keys” include F1 through F12 and the number keys 0 through 9, the four direction keys, Enter, ESC, Page Up and Page Down. The “auxiliary keys” include Backspace, +, −, Home, End, Ins, and Del.

It should be emphasized that the user interface module 11 can accept other input methods from the user in addition to the keyboard input. For example, the user can use a mouse to click and enter his request. He can also use other one-touch input controllers, such as a digital pad or a voice recognition system, to input his request. Any person skilled in the art can make various equivalent modifications without departing from the spirit and scope of the invention.

The network service request is the request entered by the user according to the network service he requires. Generally speaking, the network service request may include a web-browsing request, an email-receiving and sending request, a file-downloading request and a network-gaming request. For the convenience of the user, the user interface module can integrate some or all of these items together, and provide prompts for these items respectively.

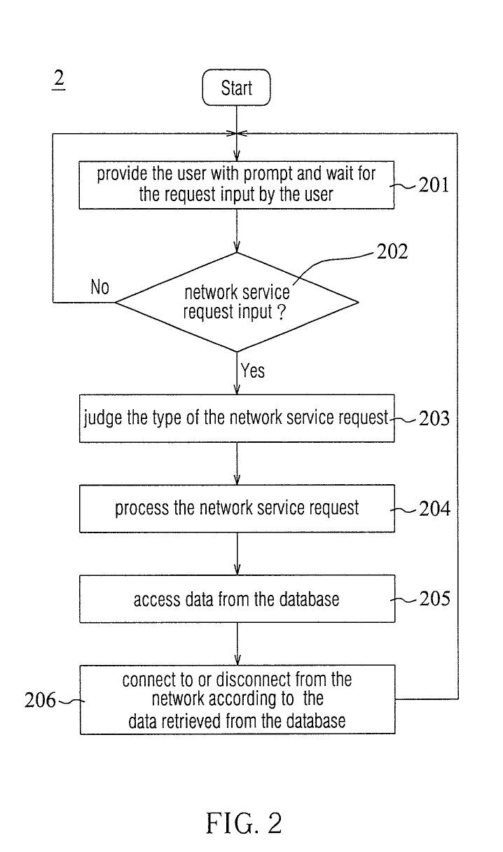

As shown in FIG. 2, the responding module 12 includes a network-connecting sub-module 121 and a network-disconnecting sub-module 122. The network-connecting sub-module 121 is for establishing connection between the system I and an ISP (Internet Service Provider) server, so that the system 1 may connect to the Internet. On the contrary, the network-disconnecting sub-module is for disconnecting the connection between the ISP server and the system 1. Since the network-connecting sub-module 121 and the network-disconnecting sub-module 122 may be the program modules used in the prior art for network connection and disconnection, the detailed descriptions of these modules are omitted.

The data managing module 13 includes a private data managing sub-module 131 and a public data managing sub-module 132. Correspondingly, the database 14 includes a private sub-database 141 and a public sub-database 142. The private sub-database 141 stores the private data, for example, the ID and the password of the user, and the public sub-database 142 stores the public data, for example, the IP address of the ISP server or the domain names of the web servers. The data managing sub-module 131 accesses the private data stored in the private sub-database 141, and the public data managing sub-module 132 accesses the public data stored in the public sub-database 142 according to the requirements from the responding module 12.

Through the above-mentioned configuration, the system 1 can complete the network connection procedures automatically according to the user's selection by only one touch, including the dial-up procedure and the log-in procedure. For example, if the user wants to browse a web page of a web server when the computer is not connected with the Internet, the system 1 can firstly establish a network connection with an ISP according to the data stored in the database 14 automatically. After connecting to the Internet, the system 1 then connects to the web server to download the content of the web page the user requested. The user does not have to carry out the complicated dial-up or network connection procedures.

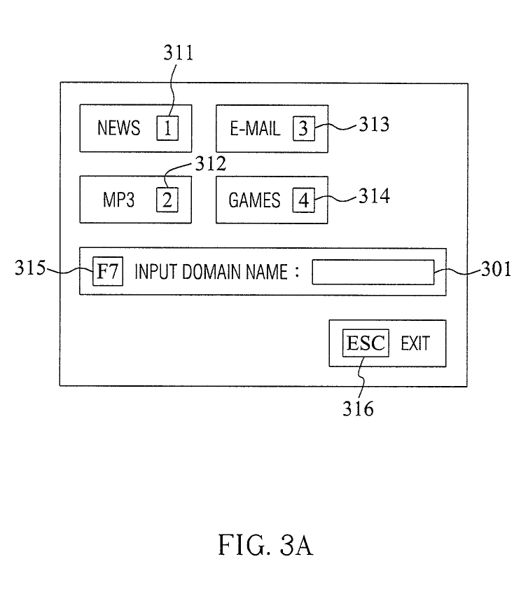

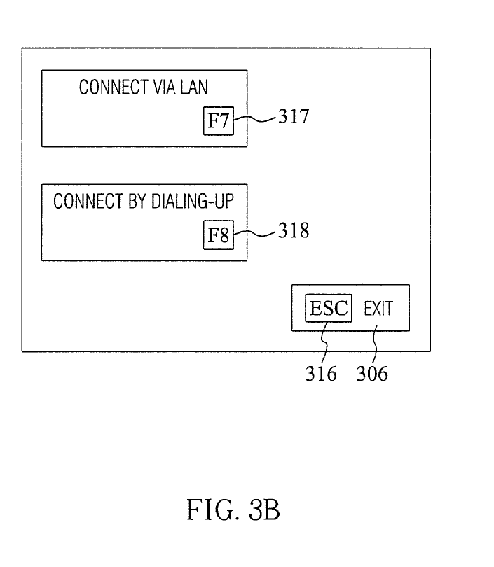

Referring to FIG. 2, in the automatic network connecting method 2 according to the preferred embodiment of the invention, the procedure 201 provides the user with at least one prompt, and waits for the request input by the user. As shown in FIG. 3(A), the user interface module 11 provides prompts 311 to 316 for all user-selectable items. Each prompt corresponds to a key on a keyboard. When the user wants to select an item, he or she can just hit the key corresponding to the item according to the prompt provided. For example, when the user wants to browse the content of a news web site, he/she can hit the key “11” according to the prompt 311. When the user wants to input the domain name or IP address of a web site manually, he/she can hit the key “F7” according to the prompt 315. When the user wants to exit, he/she can hit the key “ESC” according to the prompt 316.

In the procedure 202, when it receives any network service request sent by the user in the procedure 202, the method 2 proceeds to the procedure 203, which judges the type of the request. Then, in the procedure 204, the responding module 12 processes the request by the network-connecting sub-module 121 or the network-disconnecting sub-module 122.

To process the network service request, the responding module 12 calls the data managing module 13 to access the data stored in the database 14 in procedure 205. Then, in the procedure 206, the responding module 12 connects to or disconnects from the Internet according to the network service request sent by the user and the data retrieved from the database 14.

For example, if the user wants to connect to a news server, and the system I does not connect to the Internet, the responding module 12 firstly calls the data managing module 13 to retrieve the IP address of the ISP server, the ID and password of the user on the ISP server, and the IP address of the news server from the database 14. Since the IP addresses of the ISP server and the news server are network connection public data, and the ID and password of the user are user private data, the data managing module 13 uses private data managing sub-module 131 to retrieve the user private data from the private sub-database 141, and uses public data managing sub-module to retrieve the network connection public data from the public sub-database. Then, the network-connecting sub-module 121 connects to the ISP server according to the IP address of the ISP server and the ID and password of the user. Once the connection being established successfully, the responding module 12 connects to the news server according to the IP address of the news server retrieved from the database 14.

In view of the above, when the user wants to use a network service, the system and method according to the preferred embodiment of the invention can connect to the Internet automatically according to the data stored in the database. In other words, the user can use the network service provided by the computer more intuitively.

In the preferred embodiment, the system 1 allows the user to connect to the Internet in various ways. Referring to FIG. 3(B), for example, the user may connect to the Internet by dialing-up or via a LAN. The user interface module 11 provides different prompts for different choices. The user may choose to connect to the Internet by dialing-up by hitting the “F7” key according to the prompt 317, or via a LAN by hitting the “F8” key according to the prompt 318.

Furthermore, in the preferred embodiment, the system may store data into the database for future use. For example, the IP address of the web server the user browsed can be stored in the database. When the user wants to browse the content of the same server, he/she can select the server according to the prompt provided by the user interface module. The system can also store the IP address of the ISP server or the ID and password of the user.

Since the network connecting system and method can provide the user with prompt, the user is able to input network service request by only one touch. After receiving the request, the complicated network connecting or disconnecting procedures are processed automatically. Thus, the operation efficiency can be improved.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An automatic network connecting system, comprising:
a database for storing user private data and network connection public data;
a data managing module for accessing the user private data and the network connection public data stored in the database;
a user interface module for providing at least one prompt, so that a user can input a network service request according to the prompt in one touch; and
a responding module for receiving the network service request and accessing the user private data and the network connection public data stored in the database through the data managing module according to the network service request to complete the network service requested by the user automatically.

2. The system of claim 1, wherein the database comprises:
a private sub-database for storing the user private data; and
a public sub-database for storing the network connection public data.

3. The system of claim 2, wherein the data managing module comprises:
a private data managing sub-module for accessing the user private data stored in the private sub-database; and
a public data managing sub-module for accessing the network connection public data stored in the public sub-database.

4. The system of claim 1, wherein the responding module comprises:
a network-connecting sub-module for establishing a network connection; and
a network-disconnecting sub-module for disconnecting an established network connection.

5. The system of claim 1, wherein the network service request comprises a web page browsing request.

6. The system of claim 1, wherein the one touch comprises a hitting of a key on a keyboard.

7. The system of claim 1, wherein
the user private data comprise an ID and a password of the user; and
the network connection public data comprise the IP address of a server.

8. The system of claim 7, wherein
the server is an HTTP server.

9. The system of claim 7, wherein
the server is an ISP server.

10. An automatic network connecting method, comprising:
providing at least one prompt so that a user can input a network service request according to the prompt in one touch; and
accessing the user private data and the network connection public data stored in a database according to the network service request to complete the network service requested by the user automatically.

11. The method of claim 10, further comprising:
judging the type of the network service request.

12. The method of claim 10, further comprising:
establishing a network connection.

13. The method of claim 10, further comprising:
disconnecting an established network connection.

14. The method of claim 10, further comprising:
receiving the user private data and the network connection public data input by the user; and
storing the user private data and the network connection public data input by the user into the database.

15. The method of claim 10, wherein
the user private data comprise an ID and a password of the user; and
the network connection public data comprise the IP address of a server.

16. The method of claim 15, wherein
the server is an ISP server.

17. The method of claim 15, wherein
the server is an HTTP server.

18. A computer-readable storage medium having program codes recorded thereon; wherein the program codes make a computer execute the procedures of:
providing at least one prompt so that a user can input a network service request according to the prompt in one touch; and
accessing the user private data and the network connection public data stored in a database according to the network service request to complete the network service requested by the user automatically.

19. The computer-readable storage medium of claim 17, wherein the accessing procedure comprises:
establishing network connection.

20. The computer-readable storage medium of claim 17, wherein the accessing procedure comprises:
disconnecting an established network connection.

21. The computer-readable storage medium of claim 17, wherein the program codes further make the computer execute the procedures of:
receiving the user private data and the network connection public data input by the user; and
storing the user private data and the network connection public data input by the user into the database.
